(19) United States
(12) Patent Application Publication
(10) Pub. No.: US 2017/0129548 A1
(43) Pub. Date: May 11, 2017

(54) EASILY ACCESSIBLE AND FOLDABLE STORAGE UNIT FOR A PICKUP BED

(71) Applicant: FORD GLOBAL TECHNOLOGIES, LLC, Dearborn, MI (US)

(72) Inventor: Venkatesh Krishnan, Canton, MI (US)

(21) Appl. No.: 14/934,551

(22) Filed: Nov. 6, 2015

(51) Int. Cl. B62D 33/02

(52) U.S. Cl. CPC B62D 33/0207

(57) ABSTRACT

An apparatus for storing one or more objects in a bed of a pickup truck including a first guide track located on an inside surface of a first sidewall of the bed is provided. In one embodiment, the apparatus is a removable storage unit for positioning in the bed of the pickup truck, the unit including a second guide track adapted for slidably engaging the first guide track on the first sidewall of the bed. The unit may be collapsible. A vehicle including the storage unit is also disclosed.

### TECHNICAL FIELD

This document relates generally to the vehicle arts and, more particularly, to an easily accessible and foldable storage unit for a pickup bed.

### BACKGROUND

Pickup trucks usually include a bed that may be used for the storage of various objects. In some instances, the open upper end of the bed may be covered with a cover (sometimes referred to as a Tonneau cover), which may be rigid or soft in nature. When covered, access to the bed may be restricted to lowering the tailgate and reaching under the cover to access objects stored in the bed, which may be difficult for users who do not have a sufficient reach. Those not wishing to deal with removing the cover sometimes resort to storing objects in the seating compartment, where space may be limited and items are subject to being crushed or broken if not stored properly.

Even without the cover in place, a pickup bed typically does not include any structure that can be used to retain stored items in place, such as bags of groceries, luggage, tools, or other small items, during transport. Given that it may be used for hauling equipment or bulk materials, the floor of the bed is often dirty, and it is thus undesirable to place items like groceries on it. Some pickup trucks include bed-mounted tool boxes that may be used for storage, but these are typically expensive and heavy structures that are fixed in place and thus cannot be moved out of the way to allow for full use of the bed.

This document relates to an easily accessible and foldable storage unit for pickup truck beds. The unit would provide for convenient storage and ready access to the stored items, regardless of the presence of a cover on the pickup bed. The unit would also be reliably mounted for use, yet easily removable to account for situations where full access to the bed is desired. Easy storage of the unit when not in use would also be a desirable feature.

### SUMMARY

In accordance with the purposes and benefits described herein, an apparatus for storing one or more objects in a bed of a pickup truck including a first guide track located on an inside surface of a first sidewall of the bed is provided. The apparatus includes a removable storage unit for positioning in the bed of the pickup truck, the unit including a second guide track adapted for slidably engaging the first guide track on the first sidewall of the bed.

In one embodiment, the unit includes a base connected to a first sidewall of the unit, the first upstanding sidewall supporting the second guide track. The truck may include a third guide track located along an inside surface of a second sidewall of the bed, and the base is connected to a second sidewall supporting a fourth guide track for engaging the third guide track. The unit may further include an end wall including one or more bumpers for engaging the tailgate in a closed position, as well as at least one roller for engaging a floor of the bed.

The second guide track may be longer than the first guide track. A stop may be provided for stopping the storage unit from extending beyond a periphery of an open tailgate of the pickup truck.

In one particular embodiment, the storage unit is collapsible. The bed may also include a hanger for hanging the storage unit in a collapsed condition.

A further aspect of the disclosure pertains to a vehicle having a bed connected to the vehicle for storing objects for transport, the bed including a tailgate, upstanding sidewalls, and a first guide located on an inside surface of at least one of the sidewalls. A removable storage unit is provided for positioning in the bed. The storage unit includes a second guide adapted for slidably engaging the first guide to allow the unit to move between a retracted position and an extended position.

The first guide may be connected to a fender well forming part of the sidewall, and may have a length that is shorter than a length of the fender well (and may be substantially shorter than the second guide). The unit may include a base connected to a first sidewall of the unit supporting the second guide. A third guide may be located along an inside surface of a second fender well, and the base is connected to a second sidewall of the unit supporting a fourth guide for engaging the third guide. A stop may be provided for stopping the storage unit from extending beyond a periphery of the tailgate in a lowered condition.

The unit may include an end wall for positioning adjacent to the tailgate of the bed, the end wall including one or more bumpers for engaging the tailgate in an upright position. The unit includes at least one roller for engaging a floor of the bed.

A further aspect of the disclosure pertains to an apparatus for storing one or more objects in a bed of a pickup truck including at least one first guide located on an inside surface of a first fender well. The apparatus comprises a collapsible storage unit for positioning in the bed of the pickup truck, the unit including a plurality of interconnected sidewalls and a flexible base. The storage unit may be collapsed for storage in the bed of the pickup truck, or erected for use in storing objects in the bed of the pickup truck. The flexible base may comprise a net. In this aspect of the disclosure, guides may be provided on the unit and anywhere in the bed for connecting the two structures together, such that relative sliding movement is established to allow for extension and retraction.

In the following description, there are shown and described several preferred embodiments of the storage unit for use in connection with a pickup bed. As should be realized, the storage unit is capable of other, different embodiments and its several details are capable of modification in various, obvious aspects all without departing from the storage unit as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification illustrate several aspects of the storage unit and together with the description serve to explain certain principles thereof.

FIG. 1 is a partially cutaway perspective view of the rear of a pickup truck, showing one possible embodiment of a storage unit positioned in a retracted condition;

FIG. 2 is a partially cutaway perspective view illustrating a guide for the storage unit positioned along one sidewall of the bed (and on a fender well, in particular);

FIG. 3 is a top perspective view of one embodiment of the storage unit;

FIG. 4 is a cutaway cross-sectional view illustrating the connected guides for guiding the storage unit in moving relative to the bed;

FIG. 5 is a partially cutaway perspective view of the rear of a pickup truck, showing one possible embodiment of a storage unit positioned in an extended condition;

FIG. 6 is a partially cutaway perspective view of the rear of a pickup truck, showing a storage unit in a collapsed and stored position; and

FIG. 7 is a partially cutaway perspective view of the rear of a pickup truck with a cover on the bed, and the tailgate lowered to provide access to the storage unit.

Reference will now be made in detail to the present preferred embodiments of the storage unit, examples of which are illustrated in the accompanying drawing figures.

### DETAILED DESCRIPTION

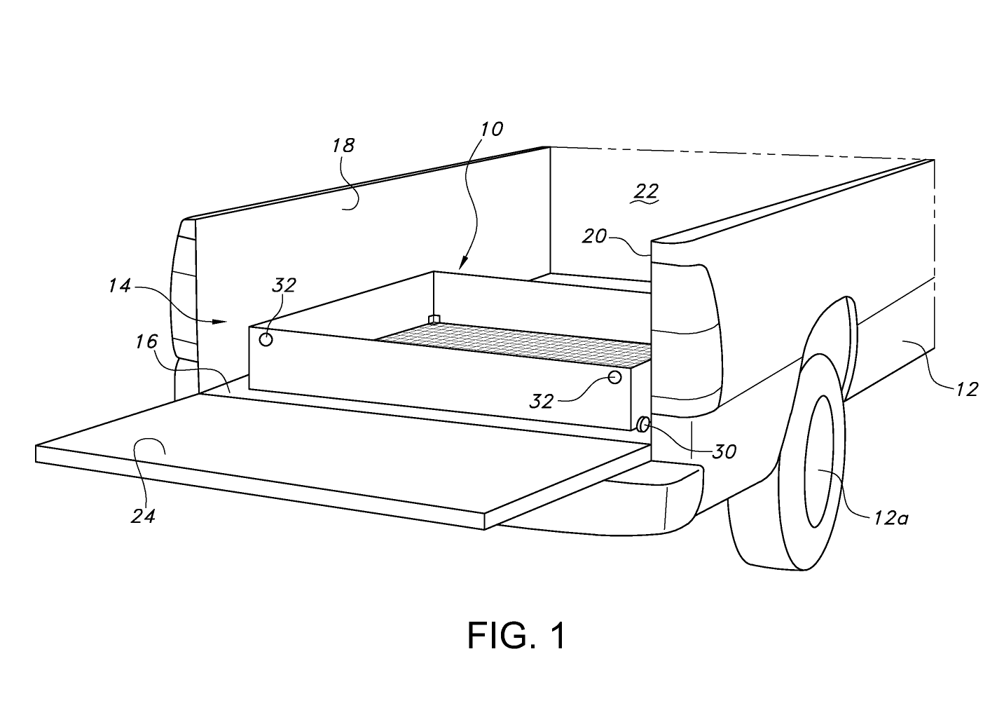

Reference is now made to FIG. 1, which illustrates a first embodiment of a storage unit 10 for a vehicle 12 with a bed 14, such as a pickup truck. The storage unit 10 is adapted for positioning with the bed 14 above a floor 16 and bounded by upstanding opposed sidewalls 18, 20 and an end wall 22. These walls 18, 20, 22, together with a tailgate 24 movable between a lowered and upright position, form an open-top box (when uncovered) for receiving objects for storage during transportation.

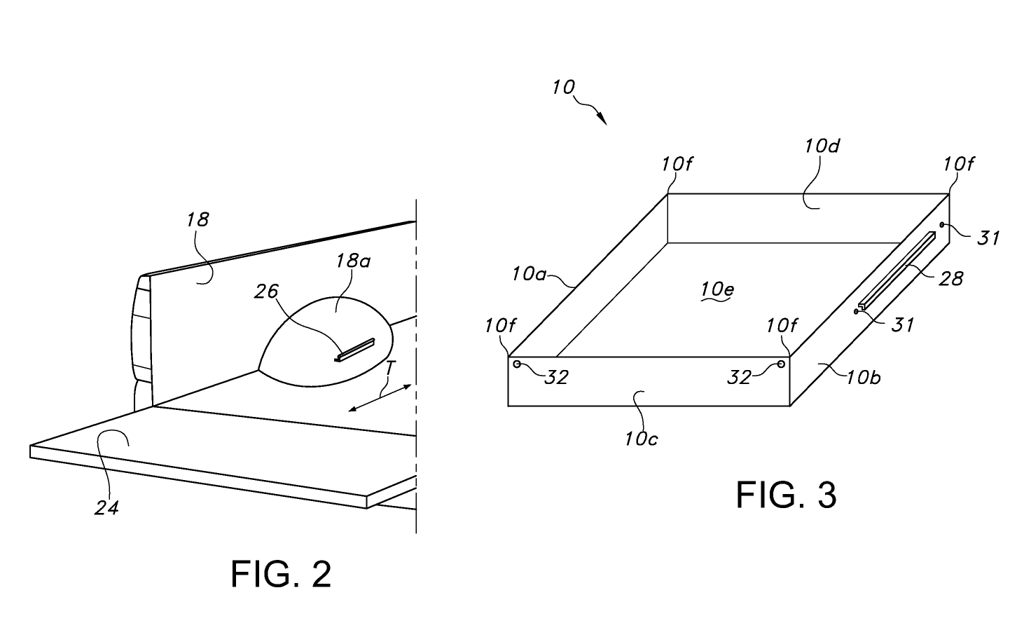

With reference to FIGS. 2 and 3, the sidewalls 18, 20 of the bed 14 may each include a guide, such as an elongated guide track 26. This track 28 in one embodiment is associated with a fender well 18a (only one shown in FIG. 2), such that it projects outwardly therefrom into the bed 14. A similar guide or guide track 28 is provided on the storage unit 10, such as along a sidewall 10a thereof (opposite wall shown in FIG. 3). The attachment of the tracks 26, 28 may be achieved using fasteners or other bonding techniques, or the tracks may be integrally formed in the respective sidewalls 18, 20, 10a.

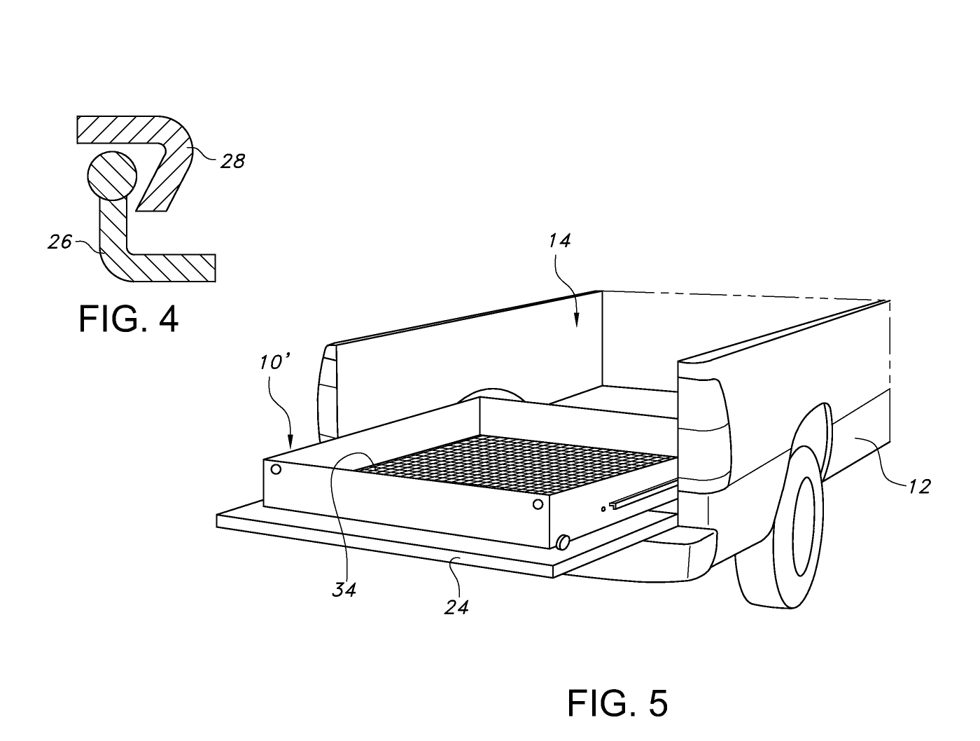

As indicated by the cross-sectional view of FIG. 4 (which would be the arrangement associated with the right sidewall 20 in the disclosed embodiment, the opposite side being a minor image), the guide tracks 26, 28 when mated form a sliding connection, and may optionally include bearing strips or like structures to create a desirable low friction engagement. This connection allows the storage unit 10 to move from a retracted position (FIG. 1) fully within the confines of the bed 14 to an extended position (10′ FIG. 5) for ready access by a user standing adjacent to the tailgate 24 in the lowered position (and even with a cover in place, as discussed below). The connection established between the unit 10 and the vehicle 12 as a result of the guide tracks 26, 28 also prevents any undesirable tilting or tipping of the storage unit 10 when moved to the extended position (or otherwise).

As can be understood by comparing FIGS. 2 and 3, the guide track 28 may be significantly longer in the travel direction T of the storage unit 10 than the guide track 26 on the fender well 18a, which as can be seen is an inwardly directed and upwardly projecting structure corresponding to the vehicle wheel 12a. This is possible since the latter remains stationary while the former moves to and fro with the storage unit 10. Indeed, it can be appreciated that the guide track 26 on the fender well 18a may be shorter in length than the length of the fender well in the travel direction T, and thus provide a minimal amount of structure within the bed 14, and thus avoid interfering with its use for other purposes when the storage unit 10 is not erected in the bed. Advantageously, the track 26 also does not contact the floor 16 of the bed 14 in this embodiment, thus leaving it fully exposed for use.

To facilitate smooth fore and aft movement during extension and retraction, the storage unit 10 may be provided with one or more rollers. In the illustrated embodiment, a roller in the form of a wheel 30 is connected to the sidewalls 10a, 10b thereof and arranged to engage the floor 16 of the bed 14. Limiters or stops 31 may be provided to define the maximum forward movement of the unit 10 as corresponding to the periphery of the tailgate 24 in the lowered condition, and possibly also in the opposite direction to prevent inadvertent disengagement. The stop or limiter may be also be provided as part of the one or more of the guide tracks 26, 28.

As perhaps best shown in FIG. 5, the end wall 10c of the storage unit 10 may also be provided with bumpers 32. The bumpers 32 may be positioned for engaging the tailgate 24 in the upright or home condition. This may help to prevent squeaking or chatter from engagement between the end wall 10c and the tailgate 24.

The storage unit 10 may be made of rigid, durable materials, such as plastic, or soft flexible materials, such as cloth or fabrics, and may be provided with one or more compartments (not shown). A lower portion or base 10e of the unit 10 may be formed of a material for supporting any objects contained therein above the floor 16 of the bed 14. The unit 10 may also comprise a collapsible body, such that the sidewalls 10a, 10b and end walls 10c, 10d can fold together to form a substantially planar unit in the collapsed condition. This may be achieved by providing flexible connections or hinges 10f at the connections between the various walls 10a-10d, and using a flexible material, such as netting 34, to form the base 10e. The guide tracks 26, 28 may be metal or a like rigid material, or could be made of a flexible material to allow for bending and removal and reconnection in a snap-fit like manner to ensure that a positive, yet releasable connection is maintained (which can be especially important when a cover is not present and the bed 14 is subjected to wind forces when the vehicle is traveling at high speeds).

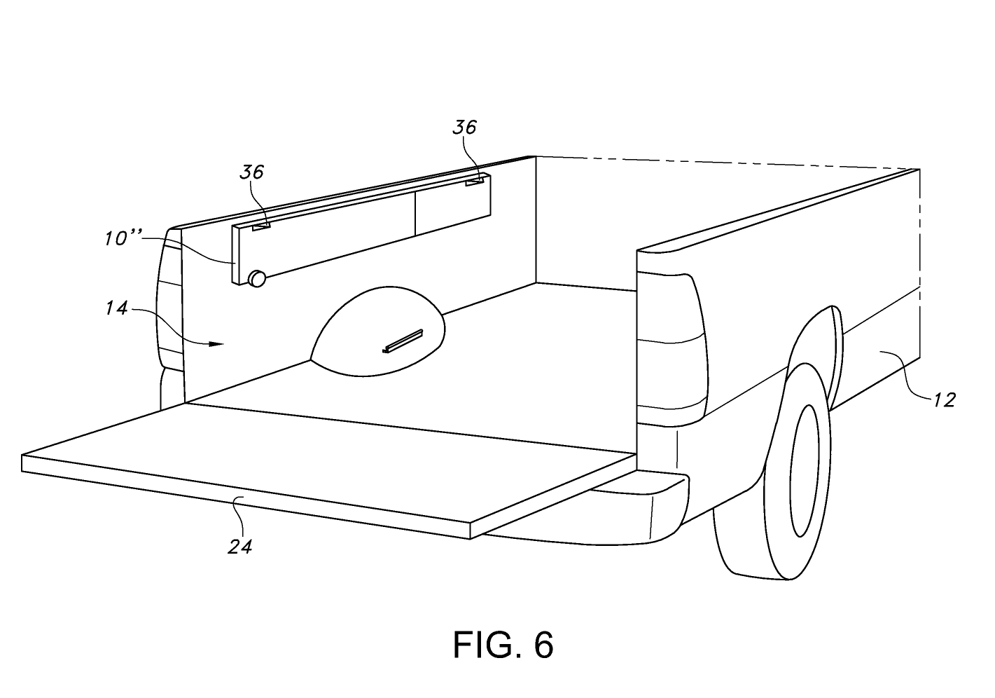

With reference to FIG. 6, it can be appreciated that, in the collapsed condition, the storage unit 10″ may be suspended by supports, such as hangers 36, on one of the sidewalls 18, 20 of the bed 14. In such condition, it can be appreciated that the bed 14 is fully exposed for use in receiving materials or objects, with the guide tracks 26 associated with sidewalls 18, 20 creating little or no interference. The bed 14 in this condition is thus able to receive materials in the typical fashion.

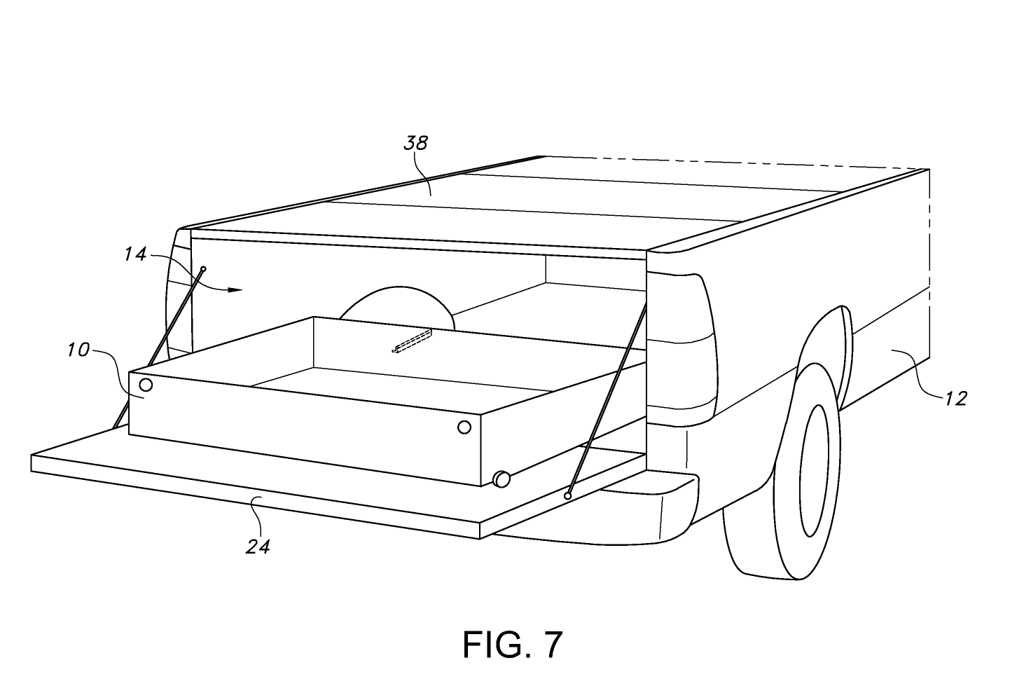

From FIG. 7, it can also be appreciated that the storage unit 10 can be fully accessed when a cover 38 is positioned over the bed 14. The tailgate 24 may be lowered and the unit 10 pulled rearward, thereby allowing full access without first removing the cover 34. To move the unit 10 to the retracted position, the operation may simply be reversed.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus for storing one or more objects in a bed of a pickup truck including a first guide track located on an inside surface of a first sidewall of the bed, comprising:
a removable storage unit for positioning in the bed of the pickup truck, the unit including a second guide track adapted for slidably engaging the first guide track on the first sidewall of the bed.

2. The apparatus of claim 1, wherein the unit includes a base connected to a first sidewall of the unit, the first upstanding sidewall supporting the second guide track.

3. The apparatus of claim 2, wherein the truck includes a third guide track located along an inside surface of a second sidewall of the bed, and the base is connected to a second sidewall supporting a fourth guide track for engaging the third guide track.

4. The apparatus of claim 3, wherein the unit includes an end wall including one or more bumpers for engaging the tailgate in a closed position.

5. The apparatus of claim 1, wherein the unit includes at least one roller for engaging a floor of the bed.

6. The apparatus of claim 1, wherein the second guide track is longer than the first guide track.

7. The apparatus of claim 1, further including a stop for stopping the storage unit from extending beyond a periphery of an open tailgate of the pickup truck.

8. The apparatus of claim 1, wherein the storage unit is collapsible.

9. A vehicle, comprising:
a bed connected to the vehicle for storing objects for transport, the bed including a tailgate, upstanding sidewalls, and a first guide located on an inside surface of at least one of the sidewalls; and
a removable storage unit for positioning in the bed, the storage unit including a second guide adapted for slidably engaging the first guide to allow the unit to move between a retracted position and an extended position.

10. The vehicle of claim 9, wherein first guide is connected to a fender well forming part of the sidewall, the first guide having a length that is shorter than a length of the fender well.

11. The vehicle of claim 9, wherein the unit includes a base connected to a first sidewall of the unit supporting the second guide.

12. The vehicle of claim 11, further including a third guide located along an inside surface of a second fender well, and the base is connected to a second sidewall of the unit supporting a fourth guide for engaging the third guide.

13. The vehicle of claim 9, wherein the unit includes an end wall for positioning adjacent to the tailgate of the bed, the end wall including one or more bumpers for engaging the tailgate in an upright position.

14. The vehicle of claim 9, wherein the unit includes at least one roller for engaging a floor of the bed.

15. The vehicle of claim 9, further including a stop for stopping the storage unit from extending beyond a periphery of the tailgate in a lowered condition.

16. The vehicle of claim 9, wherein the storage unit is collapsible, and the bed includes a hanger for hanging the storage unit in a collapsed condition.

17. An apparatus for storing one or more objects in a bed of a pickup truck, comprising:
a collapsible storage unit for positioning in the bed of the pickup truck, the unit including a plurality of interconnected sidewalls and a flexible base,
whereby the storage unit may be collapsed for storage in the bed of the pickup truck, or erected for use in storing objects in the bed of the pickup truck.

18. The apparatus of claim 17, further including a hanger for hanging the storage unit in a collapsed condition.

19. The apparatus of claim 17, wherein the flexible base comprises a net.

20. The apparatus of claim 17, wherein the pickup truck includes a first guide, and the storage unit includes a second guide adapted for slidably engaging the first guide.
